(19) United States
(12) Patent Application Publication
(10) Pub. No.: US 2023/0022790 A1
(43) Pub. Date: Jan. 26, 2023

(54) PEF COOKING DEVICE AND METHOD FOR CONFIGURING SAME

(71) Applicant: BSH Hausgeräte GmbH, Munich (DE)

(72) Inventors: Uwe Has, Unterneukirchen (DE); Barbara Heikel, Traunstein (DE); Arnulf Himmel, Traunreut (DE); Bernhard Koch, Inzell (DE); Manfred Steinbacher, Inzell (DE); Edith Wrehde, Nußdorf (DE)

(21) Appl. No.: 17/788,761

(22) PCT Filed: Mar. 3, 2021
(86) PCT No.: PCT/EP2021/055259

§ 371 Date: Jun. 24, 2022

(30) Foreign Application Priority Data
Mar. 19, 2020 (DE) 10 2020 203 521.0

(51) Int. Cl. A47J 27/00; H05B 6/62; H05B 6/54

(52) U.S. Cl. CPC A47J 27/004; H05B 6/62; H05B 6/54

(57) ABSTRACT

A household PEF cooking appliance includes a container for food to be cooked, opposing outer PEF electrodes disposed in the container, and a partition variably disposed in the container between the outer PEF electrodes and oriented parallel to the outer PEF electrodes.

The invention relates to a PEF cooking appliance which has a container for food to be cooked with a pair of opposing PEF electrodes. The invention also relates to methods for configuring such a PEF cooking appliance. The invention can be most advantageously applied to household PEF cooking appliances.

PEF cooking appliances are known in principle and typically comprise a container for food to be cooked with at least two opposing electrodes (“PEF electrodes”), to which short electric pulses (“PEF pulses”) are applied at typically high voltage by means of a signal generator. If an electrically conductive food to be cooked is situated between the PEF electrodes in the container for food to be cooked, a current path is generated through the food to be cooked, whereby the food to be cooked is cooked. The container for food to be cooked is often filled with water in this case, and the food to be cooked placed in the water. In the case of small quantities of food to be cooked in particular, it is beneficial to be able to reduce the volume between the contact plates of the processing compartment.

For example, US 2016/0150905 A1 discloses a cooking system which is suitable for cooking a food product and comprises: (a) a PEF signal generator; (b) a coupling station which comprises or is adapted to accommodate one or more processing compartments, and if the coupling station is a coupling station which is adapted to accommodate one or more processing compartments, (c) a unit which comprises the one or more processing compartments that are suitable for insertion into and removal from the coupling station, wherein the coupling station is electrically connected to the PEF signal generator and comprises electrical connections for at least one of the electrodes from each of the one or more processing compartments to the PEF signal generator when the one or more processing compartments are contained in the coupling station.

Furthermore, variable volumes signify variable load resistances for the signal generator of the PEF cooking appliance. The voltage range that must be provided by the signal generator can therefore be reduced. In this case, the electrical conductivity of the water in the container for food to be cooked is largely dependent on:

the salt content of the water,

the type of ions dissolved in the water,

the temperature of the water and/or

the surrounding air pressure.

This disadvantageously means that the electrical resistance of the processing compartment can have markedly non-linear properties. When designing the power electronics, the load resistance of the content of the container for food to be cooked is therefore a variable which, depending on the system, is subject to risk and can only be predicted to a very limited extent.

EP 3 503 678 A1 discloses a PEF cooking appliance which comprises a container, a first electrode in a fixed position, a second electrode, and a generator for pulsed electrical fields for the purpose of generating electrical impulses, said second electrode being movable.

DE 10 2010 028 780 A1 discloses a device and a method for the batch-wise heating of food, in particular meat and sausage products, which can optionally be arranged in an electrically conductive covering, in a compartment that has two separate electrodes to which an electrical voltage can be applied, the electrical voltage being an AC voltage with a frequency of 500 Hz to 10 MHz or a pulse voltage of bipolar DC-free impulses with pulse widths or pulse durations of 50 ns to 1 ms. The device is characterized in that it has two separate and opposing first wall elements forming a first pair of wall elements, and second wall elements that are likewise separated from each other and form a second pair of wall elements which, with the first pair of wall elements, delimit the cross section of a shape in a first plane and in particular peripherally surround the shape in a first plane, wherein at least one second wall element can be displaced relative to one or both of the first wall elements. By virtue of the displaceable nature of at least one wall element of the second pair relative to one of the wall elements of the first pair, the cross section of the shape can be changed so that food arranged in the shape can be compressed by displacing the second wall element.

The object of the present invention is to overcome at least partly the disadvantages of the prior art and in particular to provide a PEF cooking appliance having improved adjustability and/or improved local energy density in the water or in the food to be cooked.

This object is achieved by the features of the independent claims. Advantageous embodiment variants are specified in the dependent claims, the description and the drawings.

The object is achieved by a household PEF cooking appliance comprising a container for food to be cooked with opposing outer PEF electrodes, wherein at least one partition, this being oriented parallel to the PEF electrodes, is or can be variably disposed between the outer PEF electrodes in the container for food to be cooked.

The advantage is thereby achieved that the adjustment range, i.e. the range in which the voltage at the PEF electrodes can be set, and consequently the current through the water or through the food to be cooked in the water, said current being produced by the voltage that is present at the outer PEF electrodes, becomes narrower. Additionally or alternatively, the local energy density in the water can advantageously be improved, e.g. by reducing voltage distortions. This is achieved in that adaptation of the useful volume allows the load resistance of the content of the container for food to be cooked to be moved into a more favorable range when using the PEF cooking appliance. A further advantage of such a solution, e.g. in comparison with the use of baskets, is that it can be realized in a compact manner and occupies only a small amount of the useful volume which is otherwise available to accommodate the food to be cooked.

The household PEF cooking appliance otherwise has the usual operating components such as a PEF signal generator for generating the PEF signals or PEF pulses, etc. The PEF signal generator can be designed as a power-electronics circuit, for example. The PEF signal generator can have a voltage source, in particular a DC voltage source, whose voltage is transformed into PEF pulses by high-speed switches. The DC voltage is preferably converted into a pulsed AC voltage signal. Alternatively, the PEF signal generator can have e.g. a power factor correction filter which is attached to an AC supply voltage and whose output signal can be converted by switches into a pulsed AC voltage. The switches are in particular electronic switches such as MosFETs, IGBTs or similar. The PEF cooking appliance can also have a control facility for activating the PEF signal generator, e.g. for activating the voltage source and the switches. The PEF voltage applied to the PEF electrodes can be up to 600 V or even more, e.g. between 600 V and 750 V.

The container for food to be cooked can be permanently installed in the appliance or is removable.

Outer PEF electrodes are typically understood to mean flat PEF electrodes which delimit the maximum useful volume that is available for accommodating the food to be cooked in the container for food to be cooked. The outer PEF electrodes are disposed on opposing sides of a periphery of the container for food to be cooked. They are situated with their faces closer to the periphery than the at least one partition. The food to be cooked is therefore located between the outer PEF electrodes. The outer PEF electrodes can be designed as electrode plates, as a metallic coating of a corresponding wall region of the container for food to be cooked, etc. In particular, they can be connected to different signal outputs of the PEF signal generator.

The outer PEF electrodes of the container for food to be cooked are oriented vertically in particular, e.g. at side walls of the container for food to be cooked. The at least one partition is then advantageously likewise oriented vertically in the container for food to be cooked.

A partition here is understood to mean a structure which does not itself represent a receptacle for a food to be cooked, such as a basket or similar. It is instead used in particular to reduce the size of the useful volume of the container for food to be cooked between the outer PEF electrodes in a manner which prevents the passage of a food to be cooked, e.g. to distance the associated outer PEF electrode from the food to be cooked or to divide the useful volume into consequently smaller useful subvolumes.

In particular, the basic shape of the partition is even. It can have a cross section that is e.g. planar, slightly curved, wavy or zigzag in this case.

At least one partition being variably disposed can mean that it is movable within the container for food to be cooked. In this case, it can be built into the container for food to be cooked in a fixed or non-removable manner. Alternatively or additionally, the at least one partition can be variably disposed such that it can be removed from the container for food to be cooked, being then positionally fixed when it is inserted in the container for food to be cooked.

According to an embodiment, the outer PEF electrodes are immovably disposed in the container for food to be cooked. This has the advantage of a particularly simple structure. They can be permanently built into the container for food to be cooked for this purpose. Alternatively, at least one of the outer PEF electrodes can be displaced forwards, e.g. in a manner similar to that in EP 3 503 678 A1.

In an embodiment which is advantageous for immovable outer PEF electrodes in particular, at least one first strainer is arranged in the container for food to be cooked in front of a first outer PEF electrode, and a second strainer is arranged in front of a second outer PEF electrode, wherein a distance of at least one of the strainers from the associated outer PEF electrode can be set in a variable manner. The food to be cooked is inserted into the space between the two strainers, said space representing the then smaller useful volume. As a result of the variable distance of the at least one strainer from the associated outer PEF electrode, the advantage is obtained that an ohmic load of the content of the processing compartment can be adapted more effectively to the PEF signal generator or the signal characteristics thereof. The development of power peaks at the food to be cooked is thereby minimized. The displaceable strainers can however also be combined with movable outer PEF electrodes in principle.

A “strainer” can be understood to mean in particular a partition which has a plurality of holes whose proportion of the area represents more than 50% of the area of the partition, in particular more than 70%. As a result of setting the distance of the at least one strainer from the associated outer PEF electrode, the distance between the two strainers is also changed. The strainers are used in particular to delimit the useful volume that can be occupied by the food to be cooked in the container for food to be cooked. It is thereby possible e.g. to increase a density of the food to be cooked, to increase a height of the spatial region that is occupied by the food to be cooked and/or to limit the spatial position of the food to be cooked to specific positions.

Disposition of a strainer “in front of” the associated (closest) outer PEF electrode includes in particular being situated in the container for food to be cooked. The distance of the strainer from the associated outer PEF electrode is markedly less than its distance from the other outer PEF electrode. The minimum distance can be set in such a way that the strainer rests against the associated outer PEF electrode, otherwise the strainer is separated forwards from the associated PEF electrode.

The distance from the associated outer PEF electrode being variably settable includes in particular forward displacement of the strainer relative to the associated outer PEF electrode, such that its spatial orientation relative to the associated outer PEF electrode remains the same.

According to a development, the respective strainer is attached to the associated outer PEF electrode and in particular forms a structural unit therewith. A particularly simple assembly can be achieved thereby. Alternatively or additionally, the strainer can be secured to a wall region of the container for food to be cooked where none of the outer PEF electrodes is disposed.

According to a development, the distance of only one of the strainers can be set. This has the advantage of a particularly simple and economical structure.

According to a development, the distance of both strainers can be set. This has the advantage that the useful volume can be set in a particularly wide range.

A development is however also possible in which only one strainer is present in the container for food to be cooked. The distance thereof from the associated outer PEF electrode can be variably set. This advantageously allows a particularly economical embodiment.

According to a development, the strainers are not electrically conductive. They are then used solely to mechanically define the useful volume. This has the advantage that a particularly uniform local energy density can be provided in the water or in the food to be cooked. Such strainers can consist of e.g. an electrically non-conductive plastic.

According to a development, the strainers are electrically conductive. They advantageously then serve additionally to equalize field distortions in the region of the strainers and therefore allow a more homogeneous local energy density in the water or in the food to be cooked. Such strainers can consist of e.g. metal, electrically conductive ceramic, electrically conductive plastic, etc.

As a result of processing the food to be cooked by means of the currents generated by the PEF signals (“PEF cooking”), the food to be cooked can be either cooked and/or heated up, depending on user requirements and/or type of food to be cooked, both cooking and heating being referred to in the following as cooking or PEF cooking. PEF cooking therefore includes e.g. heating up hotdogs and cooking potatoes, etc.

According to an embodiment, the distance of the at least one strainer from the associated outer PEF electrode can be set manually, e.g. by a user. To this end, the strainer can be connected via e.g. a toothed rack to the associated outer PEF electrode or to a side wall which supports the associated outer PEF electrode.

According to an embodiment, the distance of the at least one strainer from the associated outer PEF electrode can be set in a motorized manner. This is particularly user-friendly. The motorized movement of the strainer can be controlled by the user and/or take place automatically.

According to a development, the variably settable strainer can be displaced relative to the associated outer PEF electrode and is connected by means of at least one compression spring to the associated outer PEF electrode or to a side wall which supports the associated outer PEF electrode.

According to an embodiment, the strainer is a perforated plate. This has a particularly high degree of stability. A perforated plate can be understood to mean in particular a plate, e.g. a sheet, in which the holes are made.

According to an embodiment, the strainer is a wire mesh or grid. This has the advantage that the holes can occupy a particularly large partial area of the partition.

According to an alternative or additional embodiment, the container for food to be cooked has at least one guide for insertion of the partition between the outer PEF electrodes. The partition can therefore be slotted into the guide. In its slotted-in state, the partition is immovable, i.e. cannot be displaced in the direction of one of the outer PEF electrodes in particular. This has the advantage that the useful volume available for food to be cooked is made smaller, activation of the PEF signal generator is improved and/or the number of useful volumes is increased. In the latter case, the useful subvolumes produced by the partitioning can advantageously be filled with different items of food to be cooked or food. This in turn has the advantage that even items of food to be cooked with different cooking times can be PEF cooked in a user-friendly manner. A further advantage is that the larger items of food to be cooked can be forced into a spatial orientation that is advantageous for PEF cooking. The at least one guide is advantageously so designed as to hold a partition parallel to the outer PEF electrodes. The partition divides the useful volume of the container for food to be cooked into useful subvolumes on both faces of the partition. This advantageously allows the provision of larger useful subvolumes in comparison with e.g. the introduction of a basket. The guide is oriented vertically in particular.

According to an embodiment, an electrically conductive partition is inserted into at least one guide. This has the advantage that the electrical field can be homogenized at the partition, whereby field distortions such as local voltage peaks, voltage drops, etc. can be reduced and the load resistance of the content of the container for food to be cooked during use of the PEF cooking appliance can be moved into at least a more favorable range. A further advantage is that the presence of a partition has practically no effect on the operation of the PEF pulse generator or the formation of pulses, since the impedance of the container for food to be cooked remains practically unchanged. In electrical terms, the individual useful subvolumes represent a simple series circuit.

According to a development, the electrically conductive partition is a largely impervious partition. This can be understood to include a partition which has no holes or has no holes that perceptibly affect the field distribution. Field distortion within the container for food to be cooked can be reduced in a particularly effective manner thus.

According to a development, the largely impervious partition is a wholly impervious partition, i.e. it has no holes or no holes that affect the field distribution. This has the further advantage that particularly effective reduction of the field distortion within the container for food to be cooked is achieved.

According to a development, the largely impervious partition has holes which nonetheless occupy only a comparatively small partial area of the partition, e.g. no more than 25%, in particular no more than 20% of the area of the partition. This has the advantage that a very good reduction of the field distortion within the container for food to be cooked can still be achieved, but a perceptible exchange of water can take place between the useful subvolumes that are divided off by this partition. A particularly good compromise between a reduction in the field distortion and an exchange of water is achieved when the proportion of the area of the holes lies in a range between 20% and 5%, in particular between 20% and 10%.

According to a development, the partition is an electrically conductive strainer. This has the advantage of a particularly high exchange of water between the useful subvolumes of the container for food to be cooked that are divided off by the partition, an equalization of field distortion being nonetheless achievable.

According to a development, the largely impervious partition consists entirely of metal. According to a development, the largely impervious partition has electrically conductive surfaces on both sides of a carrier that is not electrically conductive, the electrically conductive surfaces being electrically interconnected.

According to an embodiment, the electrically conductive surfaces that are present on both sides of the partition have a mirror-symmetrical shape relative to the respective opposing outer PEF electrodes. This advantageously allows a particularly homogenous field to be produced in the region of the partition.

According to an embodiment, the outer PEF electrodes have a different shape. The partition can then have correspondingly shaped electrically conductive surfaces on both faces.

Largely impervious partitions and/or electrically conductive strainers can essentially be inserted into the guides in a selective manner. Guides can also be left generally free, i.e. with no partitions inserted therein. Electrically non-conductive partitions, e.g. electrically non-conductive strainers, can also be inserted into the guides.

According to a development, the guides are (purely) mechanical guides. A partition inserted into such a guide is therefore not subjected to PEF signals. Such guides can advantageously be embodied with particular ease.

According to an embodiment, the guides are designed for the electrical contacting of partitions inserted therein and can be selectively connected to the PEF signal generator, e.g. via a switching matrix. This has the advantage that electrically conductive partitions can also be used as “inner” PEF electrodes if required. This in turn allows a particularly varied application of PEF signals to the useful subvolumes. Specifically, it has the advantage that a total impedance having to be supplied with energy by the PEF signal generator can be adapted in a particularly flexible manner to a value that is suitable for the PEF signal generator. This embodiment can be realized e.g. by designing the guides as electrically conductive guide grooves.

According to a development, at least two from the group comprising impervious partitions and outer PEF electrodes are electrically interconnected in series for application of the PEF signals. According to a development, at least two from the group comprising impervious partitions and outer PEF electrodes are electrically interconnected in parallel for application of the PEF signals. Any number of series and parallel circuits can be employed in principle.

According to a development, the application of PEF signals to the outer PEF electrodes and the electrically conductive partitions during a cooking process can be variably set. This means that the outer PEF electrodes and the impervious partitions can initially be subjected individually to PEF signals during a cooking process, or said application can be terminated during a cooking process, e.g. by opening or closing switches that are connected to the PEF signal generator, in particular electronic switches such as IGBTs, etc. of e.g. a switching matrix.

According to a development, the container for food to be cooked has a plurality of guides for partitions. If the container for food to be cooked has a plurality of guides, these can be populated as desired by impervious partitions and strainers. The container for food to be cooked can therefore advantageously be divided into two, three, four or even more useful subareas.

In the case of the embodiments described above, electrically conductive strainers and electrically conductive largely impervious partitions can generally be inserted as desired, i.e. electrically conductive strainers in place of largely impervious partitions and vice versa. The PEF cooking appliance therefore includes the development whereby in the container for food to be cooked, at least one first largely impervious partition is disposed in front of the first outer PEF electrode, a second largely impervious partition is disposed in front of the second outer PEF electrode, and a distance of at least one of the largely impervious partitions from the associated outer PEF electrode can be variably set.

The object is also achieved by a method for configuring a household PEF cooking appliance having displaceable strainers, wherein at least the distance of at least one of the strainers from the associated outer PEF electrode is increased before or after a food to be cooked is placed in the container for food to be cooked. The method can be developed in a similar way to the PEF cooking appliance and has the same advantages.

The object is also achieved by a method for operating a household PEF cooking appliance having a partition that is slotted into a guide, wherein at least one partition is inserted into a respective guide of the container for food to be cooked between the outer PEF electrodes, and a food to be cooked is then introduced into one or more of the subvolumes that are delimited by at least one partition.

The properties, features and advantages of the invention, and the manner in which these are achieved, are clearer and easier to understand in the context of the following schematic description of an exemplary embodiment, which is explained in greater detail with reference to the drawings, in which:

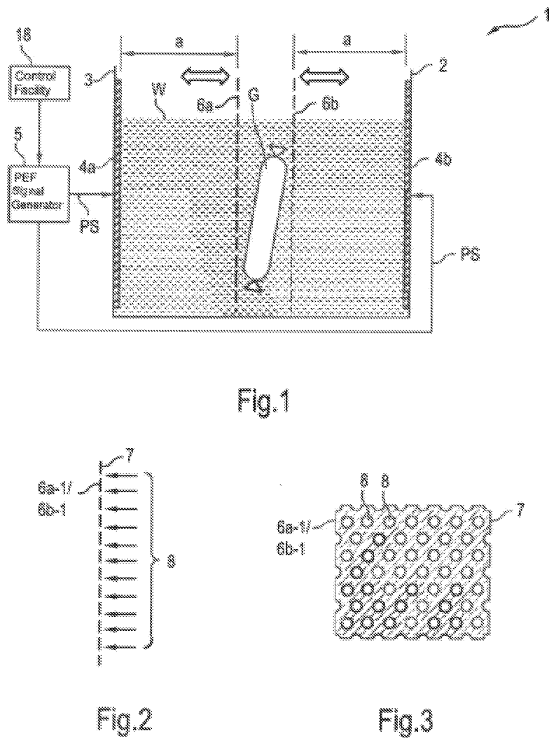

FIG. 1 shows a simplified diagram of a PEF cooking appliance according to a first exemplary embodiment, with displaceable strainers installed in a container for food to be cooked, in a sectional side view;

FIG. 2 shows a strainer according to a first variant, in a side view;

FIG. 3 shows a section from the strainer according to the first variant, in a front view;

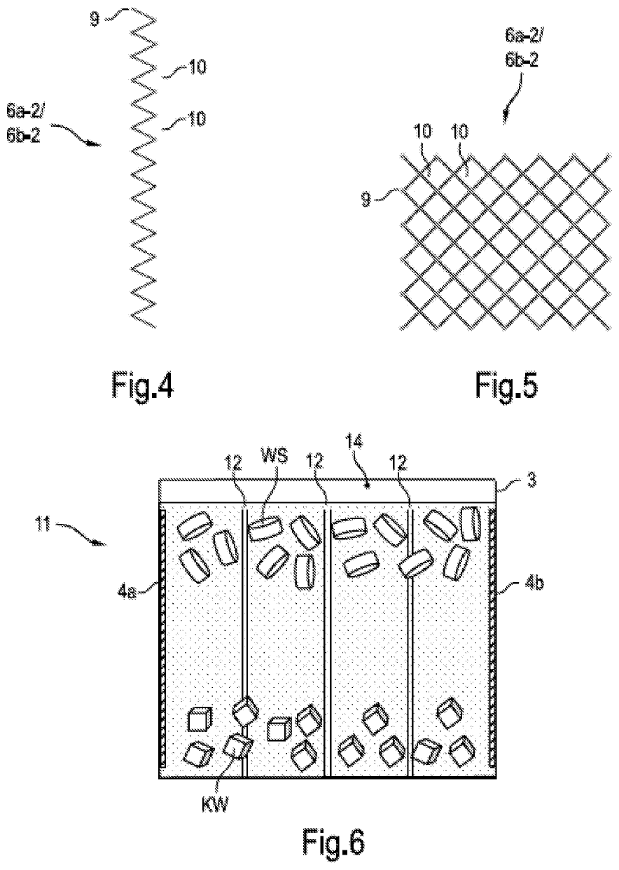

FIG. 4 shows a strainer according to a second variant, in a side view;

FIG. 5 shows the strainer according to the second variant, in a front view;

FIG. 6 shows a simplified diagram of a container for food to be cooked without partitions, in a sectional side view;

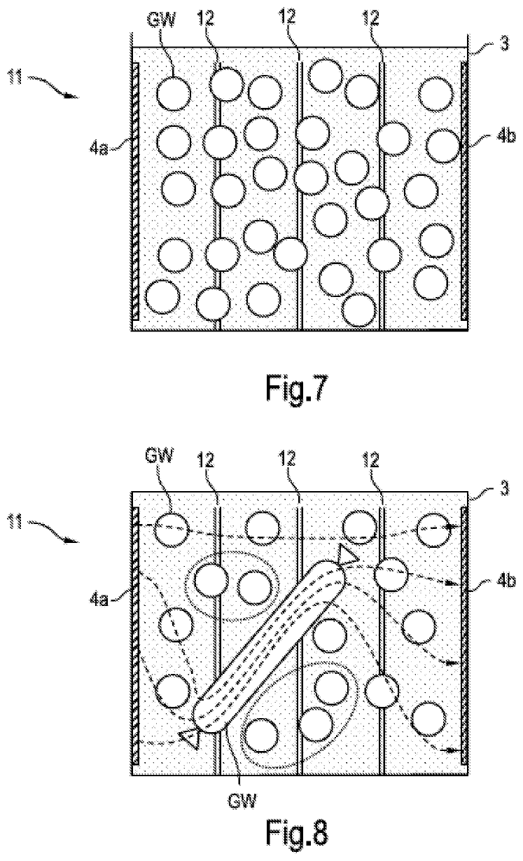

FIG. 7 shows a simplified diagram of a container for food to be cooked without partitions, filled with food to be cooked of a first type, in a sectional side view;

FIG. 8 shows a simplified diagram of a container for food to be cooked without partitions, filled with a food to be cooked in a first geometric arrangement, in a sectional side view;

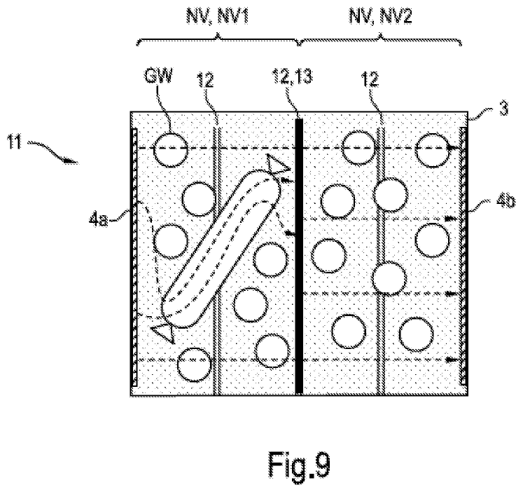

FIG. 9 shows a simplified diagram of a container for food to be cooked, filled with a food to be cooked in the second geometric arrangement with a partition, in a sectional side view; and

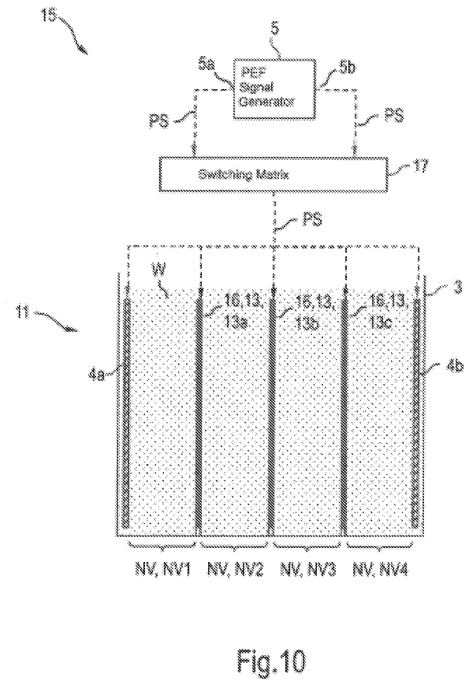

FIG. 10 shows a simplified diagram of a PEF cooking appliance according to a second exemplary embodiment, with a plurality of partitions inserted into a container for food to be cooked, in a sectional side view.

FIG. 1 shows a simplified diagram of a PEF cooking appliance 1 in a sectional side view. The PEF cooking appliance 1 has a container for food to be cooked 2 with e.g. a rectangular periphery 3. A first outer PEF electrode 4a or a second outer PEF electrode 4b are immovably disposed at two opposing periphery sections (a left-hand side wall and a right-hand side wall here). The PEF electrodes 4a and 4b are designed in the form of plates and are oriented vertically. PEF signals PS can be applied to the PEF electrodes 4a, 4b by means of a PEF signal generator 5 in a manner which is known in principle. The PEF signal generator 5 can be activated by means of a control facility 18. The container for food to be cooked 2 is filled with water W and a food to be cooked G (in the form of a hotdog here).

The container for food to be cooked 2 additionally has a first partition in the form of a first strainer 6a which is disposed in front of the first PEF electrode 4a, and a second partition in the form of a second strainer 6b which is disposed in front of the second PEF electrode 4b. The strainers 6a and 6b are designed to be electrically non-conductive and are disposed parallel to the associated outer PEF electrodes 4a and 4b respectively. The strainers 6a, 6b are variably disposed, such that their distance a from the associated outer PEF electrode 4a or 4b can be variably set, e.g. manually or in a motorized manner, as indicated by the dual-headed arrows. The two distances a can be identical or different in this case.

This embodiment variant is based on the idea that during the preparation of food to be cooked G in PEF cooking appliances 1, the food to be cooked G is immersed in water W (having higher or lower salt content) between the outer PEF electrodes 4a and 4b respectively. Upon application of the PEF signals PS, current is introduced into the water W via these PEF electrodes 4a, 4b and conducted through the food to be cooked G. In practical use, two problems are presented here: if a user (e.g. in a moment of inattention) forgets an item of cutlery such as a spoon, a fork, a skewer or any other part made from highly electrically conductive material in the container for food to be cooked 2, this can result in a short circuit between the two PEF electrodes 4a and 4b respectively. The short circuit depends on the random position of this foreign body. It may therefore be that this foreign body is not initially detected when checking for a short circuit. This means that the short circuit might only occur during the preparation. Since very high voltages and therefore very high currents can typically occur, it must be anticipated that this short circuit could result in considerable noise emission, water W spurting out of the container for food to be cooked 2, and/or that the short circuit might not be detected quickly enough and therefore results in damage to the PEF signal generator 5. Problems related to usage can also occur: during the preparation of the food to be cooked G, particularly sausage such as e.g. veal sausage, in the container for food to be cooked 2, it may be that the food to be cooked G touches a contact plate at one end and touches one of the PEF electrodes 4a, 4b at the other end. If the conductivity of the water W does not correspond to the conductivity of the food to be cooked G (the conductivity of the food to be cooked G is usually much higher than the conductivity of the water W), the food to be cooked G represents a kind of short circuit between the PEF electrodes 4a, 4b. A similar effect can occur if a plurality of pieces of food to be cooked, e.g. hotdogs, are compressed between the PEF electrodes 4a, 4b. In this case likewise, the pieces of food to be cooked represent a considerably lower resistance between the PEF electrodes 4a, 4b than the water W. Common to all of these “food to be cooked resistances” is that they are practically impossible to assess in respect of the level of their electrical resistance value. This is because the bearing pressure between the food to be cooked G and one or both of the PEF electrodes 4a, 4b can change over time. It has been shown that small and locally very pronounced maxima in the energy transmission can occur at the points of contact. This locally pronounced greater energy transmission can adversely affect the quality of the food to be cooked G due to its point-specific heating. When preparing a food to be cooked G, this benefits most when separated from the PEF electrodes 4a, 4b during a PEF cooking process, particularly advantageously midway between the PEF electrodes 4a, 4b. By covering both contact plates 4a, 4b with the strainers 6a, 6b, it is now possible—as illustrated—to effect an enforced separation of the food to be cooked G from the PEF electrodes 4a, 4b, in particular at least approximately midway between the PEF electrodes 4a, 4b.

FIG. 2 shows a side view of a strainer 6a, 6b according to a first variant 6a-1 and 6b-1 respectively. FIG. 3 shows the strainer 6a-1, 6b-1 in a front view. The strainer 6a-1, 6b-1 is embodied as a planar perforated plate, as shown in cross section in FIG. 2, having a planar metallic sheet 7 into which holes 8, e.g. round holes, are introduced in a regular pattern 8. Such strainers 6a-1, 6b-1 are particularly easy to manufacture.

FIG. 3 shows a side view of a strainer 6a, 6b according to a second variant 6a-2 and 6b-2 respectively. FIG. 4 shows a section of the strainer 6a-2, 6b-2 in a front view. The strainer 6a-2, 6b-2 in this case is embodied as a wire mesh or grid 9 which likewise has holes 10 in a regular pattern. Such strainers 6a-2, 6b-2 advantageously have holes 10 as a particularly high proportion of the area, e.g. more than 50% of the total area, in particular more than 70%.

The strainers 6a-2, 6b-2 can have a planar shape in cross section like the strainers 6a-1, 6b-1. In order to provide greater mechanical stability, it can however be advantageous for the strainers 6a-2, 6b-2 to have a basic shape that is even but be three-dimensionally shaped in cross section, which can also be referred to as a raised hole pattern. This is illustrated in FIG. 5 by an exemplary zigzag type of shape.

Alternatively, the strainers 6a-2, 6b-2 can be made from a plate, in particular a sheet, and optionally deformed in the case of e.g. a non-planar shape.

The strainers 6a-1, 6b-1, 6a-2, 6b-2 are advantageously embodied in such a way that the cross section produced by the holes 8 in the water W and available for the conductivity of current is as large as possible while good stability of the strainers 6a-1, 6b-1, 6a-2, 6b-2 is nonetheless ensured.

The distance a of the strainers 6a-1, 6b-1, 6a-2, 6b-2 is advantageously changed before or after the food to be cooked G is placed into container for food to be cooked 2, but before a PEF cooking process is started. It can however also be adapted during a PEF cooking process.

In a sectional side view, FIG. 6 shows a simplified diagram of a container for food to be cooked 11 which is designed in a similar manner to the container for food to be cooked 2 but does not have any strainers 6a-1, 6b-1, 6a-2, 6b-2 and instead has three vertically oriented guides 12 for the insertion of a respective partition 13 (see FIG. 9) that is arranged parallel to the outer PEF electrodes 4a, 4b. The container for food to be cooked 11 can be used in the PEF cooking appliance 1, e.g. instead of the container for food to be cooked 2.

The guides 12 are incorporated in the electrically non-conductive side walls of the container for food to be cooked 11 which separate the side walls having the PEF electrodes 4a, 4b from each other. The guides 12 can be provided e.g. as pairs of opposing guide grooves. In the present figure, the only guide grooves drawn in are those disposed on a side wall 14 that is drawn in at the back. The parallel side wall at the front is not drawn in. The partitions 13 can be slotted into the guides 12 from above, e.g. by a user. By way of example here, the guides 12 and the PEF electrodes 4a, 4b are disposed parallel to each other and are equidistantly spaced.

When the container for food to be cooked 11 is filled solely with water W or the electrical conductivity of the food to be cooked G corresponds to the electrical conductivity of the water W, an at least approximately homogeneous current density is established in the container for food to be cooked 11 over the entire useful volume between the PEF electrodes 4a, 4b.

In daily use, it can occur that various types of food to be cooked G or foods must be prepared simultaneously. The following problem can occur in this case:

It is assumed that food to be cooked G located in the container for food to be cooked 11 have very different conductivities, e.g. as shown here by way of example with reference to hotdog pieces WS and small vegetables, e.g. potato cubes KW. The hotdog pieces WS have a comparatively high salt content and therefore have a comparatively high electrical conductivity. By contrast, potato cubes KW are usually more likely to have a low salt content and therefore a comparatively low electrical conductivity. The potato cubes KW have a tendency to sink to the bottom in the water W and stay there. Due to their fat content, the hotdog pieces WS have a tendency to drift upwards in the water W and remain buoyant there. If these two foods WS, KW are located in the water W of the container for food to be cooked 11 at the same time, they separate accordingly. This behavior is disadvantageous for the PEF cooking process because the batch of hotdog pieces WS, due to their higher conductivity, condenses or “attracts” the current density in the container for food to be cooked 11 and the current density in the potato cubes KW is thereby reduced. Otherwise expressed, the batch of potato cubes KW reduces or “discourages” the current density there due to its lower conductivity, and therefore the current density in the hotdog pieces WS increases. This means that the energy transmission into the hotdog pieces WS is increased and into the potato cubes K is reduced. The hotdog pieces WS are consequently heated and cooked more quickly than the potato cubes KW. This lack of uniformity is inherent in the food and cannot in principle be influenced in the implementation shown. This in turn noticeably impairs the cooking result and means that items of food to be cooked G having very different electrical conductivities (the hotdog pieces WS and the potato cubes KW in the example) often cannot be heated or cooked at the same time together in a container for food to be cooked 11. This applies in particular if the food to be cooked G which only receives a reduced energy input requires a particularly high energy input because it must be not only heated but also properly cooked during the course of preparation. This relates to the potato cubes KW in the example here, because the starch must gelatinize in the potato cubes KW in order to allow optimal processing in the digestive system.

A similar problem can occur if a food to be cooked G with an extended geometry is disadvantageously oriented in the container for food to be cooked 11:

An exemplary “favorable” distribution of whole hotdogs GW is illustrated in FIG. 7 with reference to the container for food to be cooked 11 without partitions 13. The current distribution is influenced by the presence of the hotdogs GW, but no problems are anticipated here owing to the more or less uniform distribution (parallel to each other) of the hotdogs GW.

However, the current distribution can already be disadvantageously influenced to a noticeable extent if as shown in FIG. 8 a single whole hotdog GW lies transversely. This produces regions in which the local current density and the local electrical field strength as indicated by broken-line arrows drop off significantly as indicated by the dotted-line ovals. Therefore the energy input into the hotdogs GW located in these regions also drops off locally. This problem is then aggravated if different types of food to be cooked G which physically separate are placed in the water W.

FIG. 9 shows a sectional side view of the container for food to be cooked 11 which is filled with a food to be cooked G in the form of whole hotdogs GW, with a partition 13 that is inserted in the central guide by way of example. By means of the partition 13, the useful volume NV of the container for food to be cooked 11 available to accommodate food to be cooked G is divided into two useful subvolumes NV1, NV2 on both sides of the partition 13. This has the advantage that in particular larger items of food to be cooked G such as long hotdogs GW can be forced into a more uniform distribution because there is no longer space for freedom of orientation.

The partition 13 drawn in here is an electrically conductive largely impervious partition, for example,. a metal sheet or metal plate with few or no holes. It is disposed parallel to and between the outer PEF electrodes 4a, 4b and on both sides has an electrically conductive surface with the same basic shape as the respective opposing PEF electrodes 4a and 4b respectively, being mirror-symmetrical in particular.

This partition 13 has the advantage of stabilizing or homogenizing the field distribution, as indicated by the broken-line arrows, even in the case of smaller items of food to be cooked G. This is because the partition 13, due to its comparatively very high electrical conductivity, represents an equipotential area for the electrical field in the container for food to be cooked 11 or defines the position of this equipotential area in the container for food to be cooked 11. High electrical currents flow within the partition 13 in this case, and have an equalizing effect. In the present example, the electrical field is therefore homogenized on at least that side of the partition 13 which faces away from the “unfavorably” positioned hotdog GW, i.e. in the useful subvolume NV2 in which the “unfavorably” positioned hotdog GW is not present.

The division of the useful volume NV into the two useful subvolumes NV1, NV2 by means of the partition 13 corresponds to a series circuit of the two useful subvolumes NV1, NV2. This is of no importance to the PEF pulse generator 5, resulting in the further advantage that the operation of the PEF pulse generator 5 does not have to be adapted to the presence of the partition 13 as such.

It is however also possible to insert electrically conductive or non-conductive strainers 6a into the guides 12, optionally in combination with partitions 13.

FIG. 10 shows a PEF cooking appliance 15 which is fitted with the container for food to be cooked 11. The PEF cooking appliance 15 differs from the PEF cooking appliance 1 in that (a) the guides 16 are designed as guides which can electrically contact the partitions 13 and (b) the signal outputs 5a and 5b of the PEF signal generator 5 can be variably interconnected to the PEF electrodes 4a, 4b and the guides 16 via a switching matrix 17. The guides 16 are therefore so designed as to electrically contact the partitions 13 that are inserted, such that PEF signals PS can be applied thereto. The switching matrix 17 can also be a component of the PEF signal generator 5.

The switching matrix 17 can be activated e.g. by means of the control facility 18. It can have corresponding switches, in particular electronic switches such as IGBTs etc. This means that the partitions 13 can be used selectively as simple partitions or as inner PEF electrodes.

Partitions 13, specifically partitions 13a, 13b and 13c, are now slotted into all three guides 16 in the container for food to be cooked 11. This has the advantage that larger foods can be forced even more effectively into a position that is favorable for PEF cooking in the four useful subvolumes NV1, NV2, NV3 and NV4, which are then comparatively small. In addition, it is then advantageously also possible to process (cook, heat, etc.) more than two different types of food to be cooked separately. The individual useful subvolumes NV1, NV2, NV3 and NV4 can then have different impedances if they contain different types of food to be cooked G. This applies even if they have identical dimensions.

For example , the switching matrix 17 can be configured or activated by the control facility 18 in such a way that:
1) In a first switching arrangement, a first signal output 5a of the PEF signal generator 5 is connected to e.g. the first outer PEF electrode 4a and a second signal output 5b of the PEF signal generator 5 is connected to the second outer PEF electrode 4b. The partitions 13a to 13c are then used like the partition 13 in FIG. 9 as simple partitions (and not as PEF electrodes) which represent an equipotential area and divide the useful volume NV of the container for food to be cooked 11 into four useful subvolumes NV1, NV2, NV3 and NV4. In the case of a container for food to be cooked 11 that is filled with water W, this corresponds to a series circuit of the useful subvolumes NV1 to NV4. This has the advantage that field distortions in the container for food to be cooked 11 can be reduced particularly effectively.
2) In a second switching arrangement, the PEF electrodes 4a, 4b and the partitions 13a to 13c are connected alternately to the first signal output 5a and the second signal output 5b. This corresponds to a parallel circuit of the useful subvolumes NV1 to NV4. This can be realized by connecting the first PEF electrode 4a, the central partition 13b and the second PEF electrode 4b to the first signal output 5a while the two outer partitions 13a and 13c are connected to the second signal output 5b, or vice versa.
3) In a third switching arrangement, the first PEF electrode 4a is connected to the central partition 13b while both PEF electrodes 4a, 4b are connected to the second signal output 5b, or vice versa. The partitions 13b and 13c are not connected to the signal generator 5. This results in a series circuit of the combined useful subvolumes NV1 and NV2, and NV3 and NV4 respectively, wherein the two series circuits are then interconnected in parallel.
4) In a fourth switching arrangement, the first PEF electrode 4a is connected to the left-hand partition 13a while both PEF electrodes 4a, 4b are connected to the second signal output 5b, or vice versa. The partitions 13b and 13c are not connected to the signal generator 5. This results in a series circuit of the combined useful subvolumes NV2, NV3 and NV4, which are interconnected in parallel with the useful volume NV1.

However, many other switching arrangements are fundamentally possible. This has the advantage that the total impedance that must be supplied with energy by the PEF signal generator 5 can be adapted to a value which is particularly suitable for the PEF signal generator 5.

In a development, the contacting of the outer PEF electrodes 4a, 4b and the partitions 12b and 12c to the PEF signal generator 5 can be changed during a cooking process, e.g. as a function of a measured total impedance.

The present invention is obviously not restricted to the exemplary embodiment shown here.

This means that the exemplary embodiments described above can also be combined with each other where possible. This also comprises, therefore, for example, a PEF cooking appliance which has at least one displaceable strainer and at least one guide for the insertion of at least one partition.

“A/an” or “one” can generally be understood to signify one or more, particularly in the context of “at least one” or “one or more” etc., provided this is not explicitly excluded as in e.g. the expression “precisely one”, etc.

A numerical value can include both the specified number and a normal tolerance range, provided this is not explicitly excluded.

### LIST OF REFERENCE CHARACTERS

1 PEF cooking appliance
2 Container for food to be cooked
3 Periphery of the container for food to be cooked
4a First outer PEF electrode
4b Second outer PEF electrode
5 PEF signal generator
5a First signal output of the PEF signal generator
5b Second signal output of the PEF signal generator
6a First strainer
6b Second strainer
6a-1 Strainer
6a-2 Strainer
6b-1 Strainer
6b-2 Strainer
7 Sheet
8 Hole
9 Wire mesh/grid
10 Hole
11 Container for food to be cooked
12 Guide
12a Guide
12b Guide
12c Guide
13 Partition
13a-13c Partitions
14 Side wall
15 PEF cooking appliance
16 Guide
17 Switching matrix
18 Control facility
a Distance
G Food to be cooked
GW Whole hotdog
KW Potato cubes
NV Useful volume
NV1-NV4 Useful subvolume
PS PEF signal
W Water
WS Hotdog piece

1-11. (canceled)

12. A household PEF cooking appliance, comprising:
a container for food to be cooked;
opposing outer PEF electrodes disposed in the container; and
a partition variably disposed in the container between the outer PEF electrodes and oriented parallel to the outer PEF electrodes.

13. The household PEF cooking appliance of claim 12, wherein the outer PEF electrodes are immovably disposed in the container.

14. The household PEF cooking appliance of claim 12, wherein the partition includes a first strainer disposed in front of a first one of the outer PEF electrodes and a second strainer disposed in front of a second one of the outer PEF electrodes, at least one of the first and second strainers being spaced from an associated one of the first and second outer PEF electrodes at a distance which is variably settable.

15. The household PEF cooking appliance of claim 14, wherein the distance is settable manually or in a motorized manner.

16. The household PEF cooking appliance of claim 12, wherein the partition is a perforated plate, a wire mesh or a grid.

17. The household PEF cooking appliance of claim 12, further comprising a guide disposed parallel to the outer PEF electrodes in the container, said guide designed for insertion of the partition.

18. The household PEF cooking appliance of claim 17, wherein the partition is an electrically conductive partition which is inserted into the guide.

19. The household PEF cooking appliance of claim 18, wherein the electrically conductive partition is designed largely impervious or embodied as a strainer.

20. The household PEF cooking appliance of claim 17, wherein the guide is designed to electrically contact the partition inserted therein and selectively connectable to a PEF signal generator.

21. A method for configuring a household PEF cooking appliance which comprises a container for food to be cooked, opposing outer PEF electrodes disposed in the container, and strainers disposed in the container between the outer PEF electrodes and oriented parallel to the PEF electrodes, said method comprising increasing a distance of at least one of the strainers from an associated one of the outer PEF electrodes before or after the food to be cooked is placed in the container.

22. The method of claim 21, wherein the distance is settable manually or in a motorized manner.

23. A method for configuring a household PEF cooking appliance which comprises a container for food to be cooked, opposing outer PEF electrodes disposed in the container, and a partition disposed in the container between the outer PEF electrodes and oriented parallel to the PEF electrodes, said method comprising:
inserting the partition into a guide disposed parallel to the outer PEF electrodes to delimit the container into useful subvolumes; and
placing the food into one of the useful subvolumes of the container.

24. The method of claim 23, further comprising designing the partition as an electrically conductive partition for insertion into the guide.

25. The method of claim 23, further comprising designing the electrically conductive partition largely impervious or as a strainer.

26. The method of claim 23, further comprising:
designing the guide to electrically contact the partition inserted therein; and
selectively connecting the guide to a PEF signal generator.
